(19) United States
(12) Patent Application Publication
(10) Pub. No.: US 2004/0059945 A1
(43) Pub. Date: Mar. 25, 2004

(54) Method and system for internet data encryption and decryption

(76) Inventors: Kevin M. Henson, Garland, TX (US); Eric Myron Smith, Dallas, TX (US)

Correspondence Address: Robert C. Klinger, Jackson Walker LLP, Suite 600, 2435 North Central Expressway, Richardson, TX, 75080, US

(21) Appl. No.: 10/254,312

(22) Filed: Sep. 25, 2002

(51) Int. Cl. H04L 9/00

(52) U.S. Cl. 713/201; 713/150

(57) ABSTRACT

A method and system of selectively encrypting data at a server side, and selectively downloading the encrypted information to a remote user as a function of the key a requesting remote user has. The present invention is particularly advantageous to allow a server to download HTML or other type of documents to requesting remote user, and then allowing sensitive information to only be downloaded to a remote user depending on the type of key the user holds. Within the documents at the server side are tags which indicate the presence of sensitive information encrypted at the server and which may be processed by a remote user to download and decrypt the sensitive information as a function of the key level the remote user holds. Different levels of sensitive information are downloadable to a remote user, whereby when general non-sensitive information is downloadable to a user without the key. Advantageously, remote users don't even know of the presence of sensitive information at the server when they don't possess a required key as nothing is displayed. Thus, portions of the web page may be referred to as a partially invisible web page.

### CROSS REFERENCE TO RELATED APPLICATIONS

Cross reference is made to commonly assigned co-pending application Ser. No. 09/797,272 entitled “Data Encryption System”, the teachings of which are incorporated herein by reference.

### FIELD OF THE INVENTION

This invention relates generally to the field of information handling, and more specifically to a method and system for data encryption and decryption over information networks and stand alone workstations, and selective access to confidential information.

### BACKGROUND OF THE INVENTION

The security of information poses challenges for businesses and other organizations that transmit and store information. Data encryption is intended to transform data into a form readable only by authorized users. Large amounts of confidential information are passed back and forth across information networks. As the value of this information grows, there is a pressing need for security on information networks, and restricted access to confidential information, including that delivered over networks including the internet.

While known approaches have provided improvements over prior approaches, the challenges to encrypt digital data continue to increase with demands for more and better techniques having greater effectiveness. Therefore, a need has arisen for a new method and system for data encryption, especially for the access of confidential information over network including the internet.

### SUMMARY OF THE INVENTION

The present invention achieves technical advantages as a method and system selectively encrypting data at a host, without an unintended remote user even knowing the presence of encrypted information, including for delivery over the internet. A web page may have encrypted information, without any visual indication of such to an unintended user if the remote user possesses no key, or a key not having a high enough access level. A web page, for instance, will only visually produce certain information to remote users with a proper key.

Fundamentally, the method and system of the present invention implements existing encryption methods and systems, such as, but not limited to, Applicant's own encryption algorithm disclosed in co-pending application Ser. No. 09/797,272, entitled “Data Encryption System”, the teachings of which are incorporated herein by reference, within the substance of an HTML document, or other interact data. Advantageously, it is not necessary to encrypt the entire content of an HTML document (although that could be done), and there are situations where it is advantageous for part of an HTML document to be both selectively and secretly encrypted at a server. According to the present invention, a seeming mundane HTML page accessible by all remote users may contain many different layers of “secret” data that is completely hidden from view as displayed on a display. The decryption may take place in remote user client applications that act as browser helper objects or browser plug-ins. This remote user browser plug-in decrypts the embedded encrypted HTML instructions (or other data), and then replaces or appends the HTML instructions as needed to properly visually render the page at the remote user. This implementation of encryption technology for web browsers has many attractive features:

Permits authorized remote users to access specific content on protected web sites, based on the decryption keys possessed by the remote users.

Presents an alternative (potentially deceptive) web site appearance to unauthorized users.

Does not require passwords or secure transport of the content.

Maintains a Secure Favorites list on the user's browser to allow easy access to the secure sites.

In such a system the browser plug-in may be given to remote authorized users on some type of removable media such as a disk, smart card or flash memory chip either to be installed on a particular computer or to be used as a removable key on an arbitrary computer.

### BRIEF DESCRIPTION OF THE DRAWINGS

For a more complete understanding of the present invention and for further features and advantages, reference is now made to the following description, taken in conjunction with the accompanying drawings, in which:

FIG. 1 is a block diagram of a communication system incorporating the present invention;

FIG. 2 illustrates an ordinary web page consisting of three parts: a heading, some marketing text, and a link. This represents the public website that anyone would see if they accessed it without a key;

FIG. 3 illustrates the same web page as viewed by someone with a valid low security decryption key. This page has the same parts as FIG. 2, but also has two additional parts, an executive message and a second link. The additional parts are decrypted and appended to the public HTML page;

FIG. 4 illustrates the same web page as viewed by someone with a valid moderate security decryption key. In this page the elements of FIG. 2 have been replaced rather than appended. The second link from FIG. 3 is still present and a third link has been revealed;

FIG. 5 illustrates the same web page as viewed by someone with a valid high security decryption key. This page shares no elements with the pages depicted in FIGS. 2, 3, or 4, even though they are rendered for the same HTML file. All of the code has been replaced rather than appended; and

FIG. 6 is a flow diagram depicting an algorithm of the present invention.

### DETAILED DESCRIPTION OF THE PREFERRED EMBODIMENT

The present invention implements existing encryption methods and systems, such as, but not limited to, Applicant's own encryption disclosed in patent application Ser. No. 09/797,272, entitled “Data Encryption System”, the teachings of which are incorporated herein by reference, which teaches symmetric, a-symmetric, linear and non-linear encryption, within the substance of an HTML document, or other Internet data. A seeming mundane HTML page may contain many different layers of “secret” data that is completely hidden from view as displayed on a display. A class of digital document exists in which the format instructions are carried out dynamically by a viewer or browser program. These documents include, but are not limited to, HTML, DHTML, SHTML, and XML documents. Within these documents are “tags” that indicate to the viewing program of a remote user how to handle or render document elements. Certain classes of applications change the way viewers or browsers handle document elements. These applications vary in structure and function, and are called by various names such as browser helper objects or browser plug-ins, ActiveX Controls, java scripts, applets and there are others. In general, this entire category of software that modifies software may collectively be called “plug-ins”.

There is nothing special about a tag by itself, except that a remote user browser according to the present invention is uniquely programmed to identify and process the tag. The general expression for a tag is in the following form:

<X> Information </X>

If a remote user browser or one of its plug-ins recognizes the meaning of an <X> tag, some special action is responsively taken on “Information”. The </X> is a terminator and means that special action is not required for anything else. The meaning and actions associated with any particular value of X (tag) are arbitrary and defined by generally agreed upon conventions or standards. If a particular piece of remote user software encounters a tag it doesn't recognize, the tag, its associated information, and its terminator are ignored. Plug-in developers are free to develop new tags and actions as they see fit.

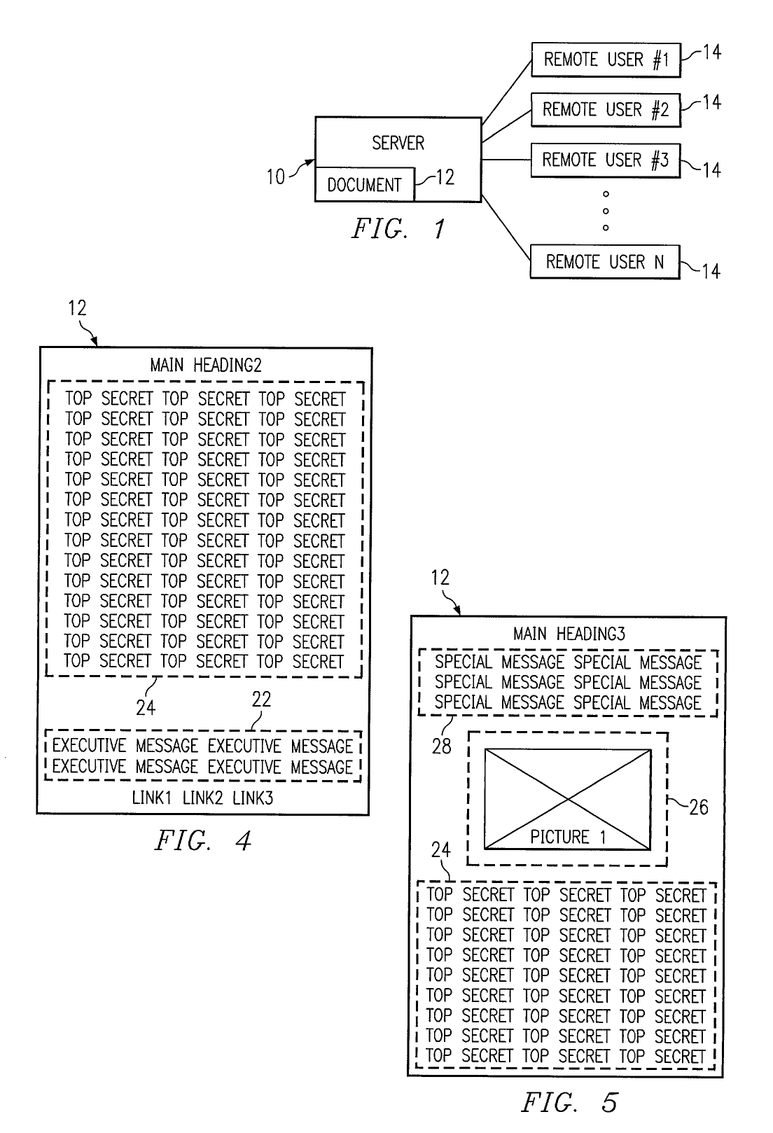

Referring to FIG. 1, the system and process of the present invention starts when some party, who will be referred to as an administrator, creates a document 12 that is published to an information network on a computer referred to as a server 10. The administrator wishes for one or more parties, referred to as remote users 14, to have selective access to this document 12 and portions thereof stored on server 10. Those parties 14 are throughout this document called users, and their computers are referred to “as clients”. In this example, some of the information of the document 12 is available to all users 14, and portions of the sensitive information of the document 12 are only available to authorized users 14 according to the key security level possessed by users 14.

The administrator establishes what information in the document 12 is sensitive, and which of users 14 should have access to it and portions thereof. It is important to note that many levels of sensitive information are carried in a single document 12. Using an AsierWeb GUI toolkit or text editor manufactured by Asier Technology of Plano Tex., the administrator of server 10 identifies files with tags indicating sensitive portions to be encrypted such as the following:

Ex: <P id=my_jag> This paragraph is sensitive.</P>

The sensitive data (HTML, images, file links) is extracted from the document 12 and encrypted, such as using Applicant's previously cross referenced encryption technology, or other encryption algorithms. This sensitive encrypted data may be saved into a separate file on the server 10 with an ActiveX control taking its place on the original page 12, or simply have the cipher text maintained within special tags. When the sensitive encrypted data is stored in a separate encrypted file an ActiveX Control is placed onto the original page 12, and an encrypted configuration file is also created on the server 10. This configuration file contains information on how to handle code replacement, user levels, key relationships and other vital data. The administrator uploads the HTML, encrypted content files, and an encrypted configuration file to the server 10. There is no place on the server 10 where the sensitive data exists unencrypted.

The administrator may at his or her option assign UserID's to authorized users 14 along with the appropriate keys. The keys may be provided with a utility program that installs the plug-in, decryption key, and if necessary, the UserID information on the user's client computer 14. In such a system the browser plug-in may be given to authorized users on some type of removable media such as a disk, smart card or flash memory chip, either to be installed on a particular computer, or to be used as a removable key on an arbitrary computer.

An Authorized User 14 installs AsierWeb client from suitable media, and sets up their assigned unique UserID if applicable, browser plug-in, or ActiveX control and key(s). Keys can be provided separately from program files, but only a valid key AND UserID will work.

Within the encrypted parameter file on the server 10 is a reference to a UserAuthorization file. If a UserID of a remote user 14 is not in this file, the software won't run. The file is also encrypted, and cannot be altered (it's on the server, and users 14 do not have read/write access). If the UserID and Key of a remote user 14 are found in this file, the decryption algorithm proceeds for tags associated with that key. A remote user 14 can be revoked for some keys, but still be a valid user for other keys.

The clean web page downloads and the ActiveX control therein is activated by the remote user's browser. The server control reads a KeyID from the file and checks to ensure the remote user has this page key. The page key is used to decrypt the URL address of the parameter file on the server 10, and also to decode that file when it is downloaded to the remote user. Inside the parameter file is a list of tags to be processed in sequential order. Some tags will not be present at first because they are inside the HTML that is loaded by an earlier tag, this is called nesting or recursion.

The authorized remote user navigates to the secured web site on server 10, and the appropriate content is downloaded, decrypted, and presented to the remote user 14 in it's browser. Many images on web pages will not need to be encrypted. The ActiveX Control on a web page is merely a special identifier (called a GUID) that is used to refer to programs in the remote user's Windows Registry.

Owners of AsierWeb (without the right key or UserID) will have their ActiveX control software activate, but it will fail to decode the filename of the parameter file, and so they will not be able to access any further content. An authorized remote user 14 may have keys for one or more tags on a page, but not all of the tags. AsierWeb decodes the tags for which the remote user 14 has a valid key, and it will simply ignore the rest. Non-owners of AsierWeb don't own the software, so the browser totally ignores the ActiveX Control.

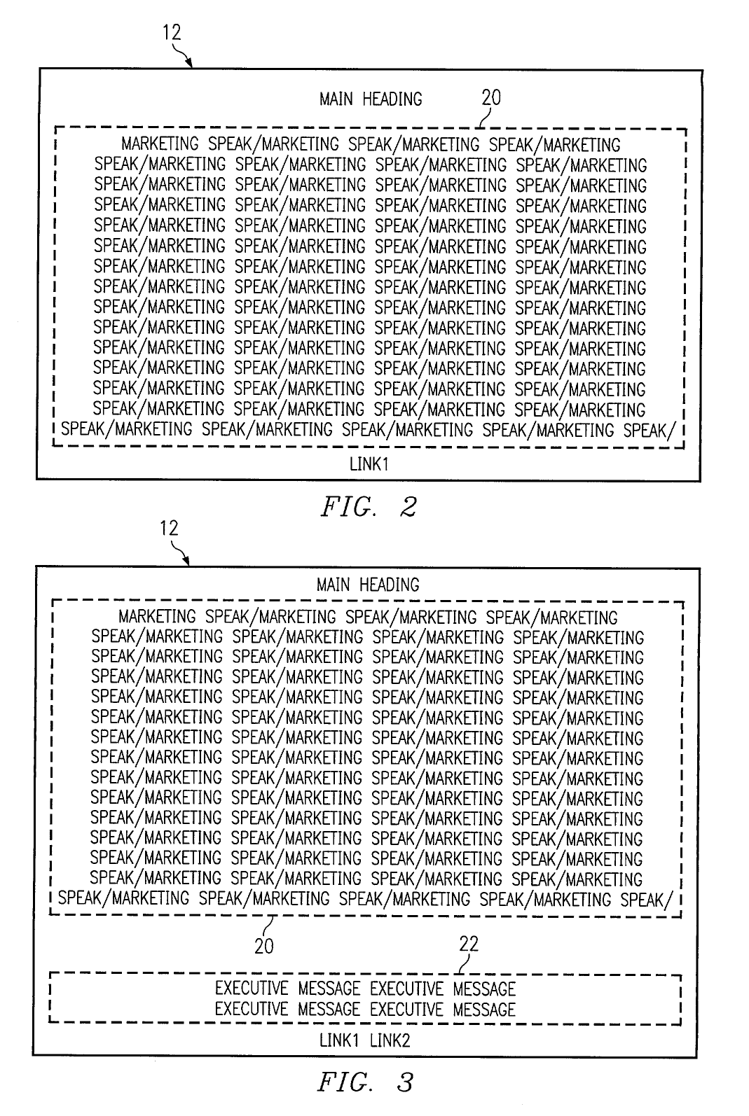

Referring now to FIG. 2, there is generally shown at 20 a web page document 12 whereby the generally available non-secure content, which is never encrypted, is shown at 20. Advantageously, it is noted that encrypted information is not viewable to non-authorized remote users 14, and thus, unauthorized remote user 14 won't even know that there is other information available on this common web page as the Active X control on the web page 12 is not a viewable identifier.

Referring to FIG. 3, there is depicted the web page document 12 whereby the generally available content 20 is displayed, along with a first level of encrypted information 22 which is responsively decrypted and downloaded to the remote user 14 upon the server 10 identifying both a valid user ID and key possessed by the remote user. This decrypted sensitive information 22 may be the first level of security of the content in document 12.

Referring now to FIG. 4, there is depicted the first level of secured information decrypted, downloaded and displayed at the remote users computer at 22, and in addition, even more sensitive information being decrypted, downloaded and displayed at the remote user 14 as shown at 24. Thus, when a remote user 14 has a valid user ID and multiple keys, such as keys allowing the remote user to download and view first and second levels of sensitive information, both this information is viewable with the un-secure information as shown in FIG. 4.

Referring now to FIG. 5, there is shown yet another embodiment wherein the most sensitive information is decrypted, downloaded and viewable by a remote user 14 when the remote user 14 has a key allowing it to access the most sensitive information, such as shown at 26. This remote user may have a key to allow it to decode another type of sensitive information as shown at 28, whereby again, the keys that the remote user possesses determine which of the sensitive information pieces are decrypted, downloaded and displayed by the requesting remote user. Again, it is noted that the information that is not accessible by a remote user and is not displayed, nor is there even a code displayed, thus, a remote user with only some keys will not even know there is additional information to be downloadable if they were to possess another key. This has special security advantages in that one trying to hack into a server will not even be tipped to know there is additional information to access when they attempt to download the generally available non sensitive information.

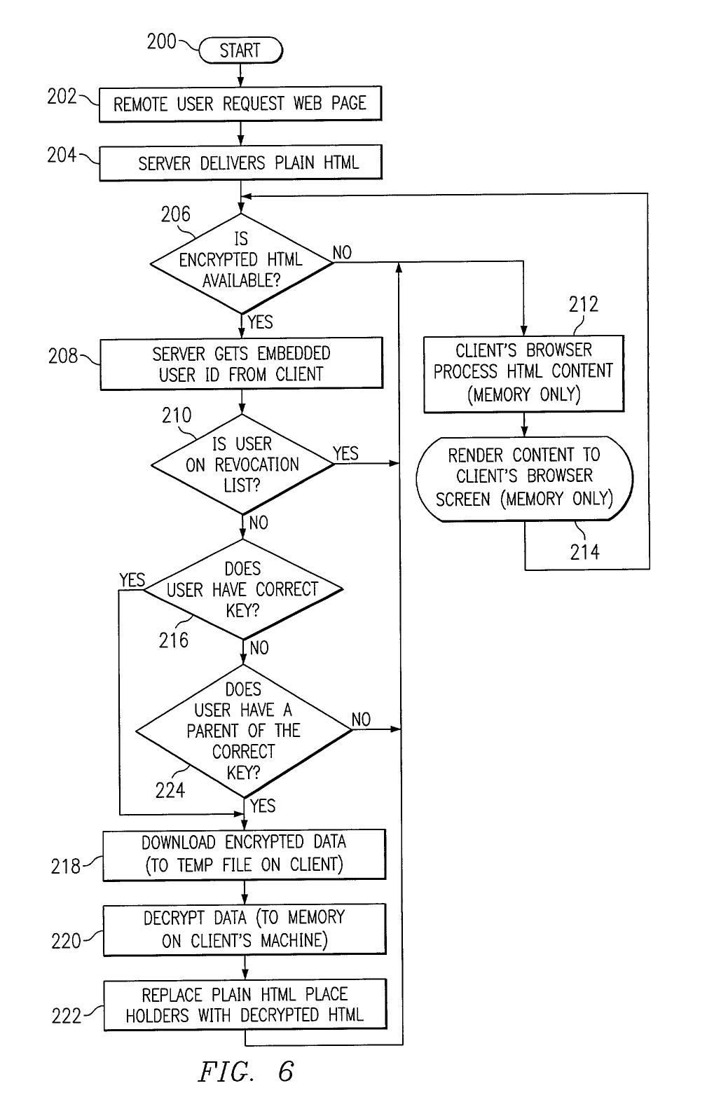

Referring now to FIG. 6, there is depicted an algorithm for the invisible web download and display algorithm of the present invention. The algorithm starts at step 200, whereby a remote user 14 requests a web page from server 10 at step 202. At step 204, the server 10 responsibly delivers and downloads the plain HTML information to the requesting remote user 14.

Next, at step 206, the server 10 determines if there is encrypted information available associated with this requested HTML page. If so, the server 10 at step 208 obtains and processes the embedded user ID from the remote user 12 at step 208.

At step 210, if the server 10 determines the requesting remote user 14 is on a revocation list, then the remote user's browser can process and retrieve only the generally available HTML content, as shown at 212. Thereafter, the remote users browser will display only the generally available non-sensitive content to a display screen at step 214, as shown in FIG. 2. Thereafter, the algorithm proceeds back to step 206, as shown.

If at step 210 a remote user is not on the revocation list, then the algorithm proceeds to step 216 whereby the server 10 determines if the requesting remote user 14 has the correct key in association with the correct user ID. If so, at step 218 the server 10 downloads the encrypted data associated with the key the remote user possesses to a temporary file on the server 10. Next, the server 10 decrypts this downloaded encrypted data and downloads it to the memory on the remote user's computer at step 220.

Thereafter, at step 222, the remote user's computer replaces the plain HTML page with the additional decrypted HTML data provided by the server 10, whereby this decrypted information is provided into memory only associated with the remote user's browser at step 212, and is rendered to the remote user's screen at step 214. It is noted that only sensitive information associated with the key that the remote user 14 possesses is downloaded to the server temp file, decrypted, and downloaded to the remote user.

Referring back to step 216, if the user does not have a correct key, although it may have a correct ID, it is determined at step 224 if the remote user has a parent of the current correct keys. If the answer is yes, then the algorithm proceeds back to step 218 and processes as previously described. If, however, at step 224 the answer is no, then the algorithm proceeds back to step 212 and only the general non-sensitive information is downloaded to a remote user's browser for processing and display at steps 212 and 214.

As depicted pictorially in FIG. 2-5, different types and security levels of information will be downloaded and displayed by a remote user, depending on the key or keys the server determines the requesting remote user to have. This provides multi-level access to sensitive information by a remote user, as determined by the administrator of server 10. Again, because the sensitive information is stored only in it's encrypted form on server 10, and because remote users do not have the ability to read/write to the encrypted data files, the administrator of server 10 maintains control and dissimilation of the sensitive information.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

We claim:

1. An information system, comprising:
a storage media storing information, whereby at least some of the information is encrypted and some is non-encrypted; and
a delivery module capable of determining if a remote user possesses a key associated with some of the encrypted information, whereby the delivery module is adapted to download the non-encrypted information to a remote user, and in addition, at least some of the encrypted information when the remote user is determined by the delivery module to possess a key associated with the encrypted information.

2. The system of claim 1 whereby the encrypted information is discerned from the non-encrypted information with tags associated with the encrypted information.

3. The system of claim 1 in whereby multiple keys are used by the delivery module to encrypt different content within a same document forming the encrypted information.

4. The system of claim 1 wherein the storage media comprises a server.

5. The system of claim 4 wherein the server has many different sets of content secured with different keys for a same URL.

6. The system of claim 1 wherein the encrypted information is adapted to be decrypted by the remote user.

7. The system of claim 1 wherein the encrypted information comprises one encrypted page having a link to other encrypted pages.

8. The system of claim 1 wherein the delivery module is adapted to compare a remote user's key against a revocation list associated with the delivery module to determine the key is valid.

9. The system of claim 2 wherein the encrypted information associated with the tag represents information selected from the group comprising of:
a link, a text block, multimedia elements including pictures, sounds, animations, movies and new-media elements.

10. The system of claim 1 wherein the confidential information is stored using symmetric encryption.

11. The system of claim 1 wherein the confidential information is stored using a-symmetric encryption.

12. The system of claim 1 wherein the confidential information is stored using linear encryption.

13. The system of claim 1 wherein the confidential information is stored using non-linear encryption.

14. An information system, comprising:
a host having:
a storage media storing information, whereby at least some of the information is encrypted and some is non-encrypted;
a delivery module adapted to deliver information upon detecting a key associated with some of the encrypted information, whereby the delivery module is adapted to download the non-encrypted information and in addition, at least some of the encrypted information upon detecting the key associated with the encrypted information; and
at least one remote user having the key and adapted to selectively obtain said encrypted information from the host via a communication network.

15. The system as specified in claim 14 wherein the encrypted and non-encrypted information is a web page.

16. The system as specified in claim 14 wherein the key is adapted to permit access to an associated level of said encrypted information.

17. The system as specified in claim 14, wherein the host has different sets of content within a common document and the content is secured with different keys as said confidential information.

18. The system as specified in claim 17 comprising multiple said remote users, whereby different said remote users have different said keys permitting access to different said sets of content within said common document.

19. The system of claim 14 wherein the encrypted information is discerned from the non-encrypted information with tags associated with the encrypted information.

20. The system of claim 19 wherein the tags are recognizable by only certain said keys.

21. The system of claim 19 wherein the keys have hierarchy.

22. The system of claim 14 wherein the host comprises a server.

23. The system of claim 17 wherein the common document is a URL.

24. The system of claim 14 wherein said confidential information has links to other said confidential information.

25. The system of claim 24 wherein the links are a function of the key the remote user possesses.

26. The system of claim 14 wherein the remote user is adapted to decrypt said encrypted information using a device from the group comprising of:
a browser helper object, a browser plug in, and a specialized browser.

27. The system of claim 14 wherein the key is stored securely at said remote user.

28. The system of claim 27 wherein the key is stored on a removable storage media.

29. The system of claim 14 wherein the confidential information is stored using symmetric encryption.

30. The system of claim 14 wherein the confidential information is stored using a-symmetric encryption.

31. The system of claim 14 wherein the confidential information is stored using linear encryption.

32. The system of claim 14 wherein the confidential information is stored using non-linear encryption.
